(19) United States
(12) Patent Application Publication
(10) Pub. No.: US 2026/0184508 A1
(43) Pub. Date: Jul. 2, 2026

(54) PROCESS FOR THE AUTOMATED HANDLING OF PRODUCTS TO BE STORED IN A STORAGE WAREHOUSE

(71) Applicant: G.D S.P.A., Bologna (IT)

(72) Inventors: Marco TAGLIAVINI, Bologna (IT); Franco Paolo BRIGANTI, Bologna (IT); Raffaele PRINCIGALLO, Bologna (IT); Gabriele FABBRI, Bologna (IT); Federico ORAZIO, Bologna (IT); Emilio TIRELLI, Bologna (IT); Giovanni MANZIERI, Bologna (IT)

(21) Appl. No.: 19/126,109

(22) PCT Filed: Oct. 30, 2023
(86) PCT No.: PCT/IB2023/060900

§ 371 Date: Apr. 30, 2025

(30) Foreign Application Priority Data
Nov. 2, 2022 (IT) 102022000022497
Jun. 30, 2023 (IT) 102023000013650

(51) Int. Cl. B65G 1/137

(52) U.S. Cl. CPC B65G 1/1371

(57) ABSTRACT

A process for the automated handling of products to be stored in a storage warehouse. The process includes placing the products in a transport tray provided at a product receiving station, separating the products according to product type. Subsequently, the transport tray is transferred to an intermediate automatic warehouse by a first automatic driven vehicle and is stored in a predefined location. When the storage warehouse is ready to receive the products, a request to withdraw the transport tray is sent to the intermediate automatic warehouse and, following this withdrawal request, the transport tray is transferred to the storage warehouse by an automatic driven vehicle which may or may not coincide with the first automatic driven vehicle. Subsequently, the products are picked up and put in a collection tray provided at the storage warehouse. This collection tray is then stored in a predefined location within the storage warehouse.

### FIELD OF THE INVENTION

The present invention relates to a process for the automated handling of products to be stored in a storage warehouse.

### BACKGROUND

In the context of production company logistics, it is particularly important to handle as efficiently as possible the flow of products within a plant between the product receiving stations and the warehouse where these products are to be stored in anticipation of their future use (this warehouse is herein referred to as “storage warehouse”).

In particular, it is desirable that the products to be stored, after reaching the product receiving stations and being uploaded into the computer system that handles the storage warehouse, are sent to the storage warehouse with timing and provisions which are suitable to allow them to be stored immediately, so as to avoid the products stopping or remaining in areas of the plant other than the storage warehouse.

However, the Applicant has noted that generally, especially in medium to highly automated companies equipped with medium to large automated warehouses, the operations of inserting products into the storage warehouse and withdrawing those products from the storage warehouse are controlled by a special warehouse management software. In these cases, the timing with which the products to be stored arrive at the product receiving stations and are handled at these stations is different from the storage timing imposed by the warehouse management software. It is therefore common to see within factories products parked and/or stacked in the vicinity of the storage warehouse waiting to be picked up and placed in the warehouse, to the detriment not only of the tidiness and optimisation of space within the factory, but also of the warehouse operator's ability to easily and quickly locate the various products to be stored from time to time following the storage order imposed by the warehouse management software.

The Applicant has noted that drawbacks similar to those mentioned above can also occur in those cases where all or part of the product storage operations are carried out by warehouse operators, such as in the case of companies without automatic warehouses or companies where, although an automatic warehouse is provided, products are handled by warehouse operators before being delivered to the automatic warehouse. These operators are not necessarily always in a position to immediately handle the products arriving from the product receiving stations.

The Applicant has also noted that the above-mentioned drawbacks are accentuated by the following factors:
the products arriving at the product receiving stations are of different types and must therefore be stored in different locations in the storage warehouse;
the aforementioned products arrive at the product receiving stations and/or at the storage warehouse at different times;
once loaded into the computer system that handles the storage warehouse, the aforementioned products must be removed from the product receiving stations as soon as possible so that other products can be handled at the product receiving stations.

All these factors imply that the product handling times at the product receiving stations vary depending on the case and are not however predictable in advance, thus making it almost impossible to coordinate these times with those imposed by the warehouse management software.

The Applicant therefore thought about how to handle the flow of products within a plant between the product receiving stations and the storage warehouse in an automated and efficient manner, while overcoming the aforementioned drawbacks caused by the misalignment of product handling times at the product receiving stations and the storage warehouse.

The Applicant realised that in order to achieve an efficient handling of the products to be stored, it is first of all advisable for the products arriving at the product receiving stations to be arranged in a transport tray according to product type, so that identical products can be stored in a storage warehouse location.

The Applicant also realised that in order to achieve automated handling of the products to be stored, it is advisable to move the products between the product receiving stations and the storage warehouse by automatic driven vehicles handled by the warehouse management software. In this way, as soon as the products at a product receiving station have been uploaded into the computer system that handles the storage warehouse, the warehouse management software can send an automatic driven vehicle to that product receiving station, so that the aforementioned products can be removed from that product receiving station in a timely manner.

The Applicant also realised that it is possible to overcome the drawbacks caused by the misalignment of product handling times at the product receiving stations and the storage warehouse by providing within the plant an intermediate automatic warehouse in which products from the product receiving stations can be temporarily stored and sent to the storage warehouse only when the latter is ready to store them. This intermediate automatic warehouse therefore absorbs the difference in timing between the product receiving stations and the storage warehouse. It receives products from the product receiving stations and then release them according to the storage order imposed by the warehouse management software. The intermediate automatic warehouse therefore acts as an automatic sequencer.

### SUMMARY

The present invention therefore relates to a process for the automated handling of products to be stored in a storage warehouse.

Preferably, these products are placed in a transport tray provided at a product receiving station.

Preferably, products are placed in the transport tray by separating them from each other according to product type.

Preferably, after placing these products in the transport tray, the transport tray is transferred from the product receiving station to an intermediate automatic warehouse.

Preferably, this transfer is carried out by a first automatic driven vehicle.

Preferably, the transport tray is stored in a predefined location within the intermediate automatic warehouse.

Preferably, when the storage warehouse is ready to receive the products placed in said transport tray, a request to withdraw the transport tray is sent to the intermediate automatic warehouse.

Preferably, following the sending of this withdrawal request, the transport tray is transferred from the intermediate automatic warehouse to the storage warehouse.

Preferably, this transfer is carried out by an automatic driven vehicle that may or may not coincides with the first automatic driven vehicle.

Preferably, said products are picked up from the transport tray and placed in a collection tray provided at the storage warehouse.

Preferably, the collection tray is stored in a predefined location within the storage warehouse.

Thanks to the provision of the intermediate automatic warehouse and the use of automatic driven vehicles, it is possible to automate all the operations from the loading of the products into the computer system that handles the storage warehouse to the delivery of the products to the storage warehouse, sequencing the automatic sending of the products to the storage warehouse according to the storage order imposed by the warehouse management software regardless of the handling time of the products at the product receiving stations.

The present invention may have at least one of the preferred features described below, taken individually or in combination.

Preferably, said products are identified at the product receiving station by reading a product identification code correlated to each of said products or to a plurality of identical products. This can be done before or after placing said products in the transport tray, preferably before placing said products in the transport tray.

Preferably, said product identification code is printed on an accompanying document correlated to each of said products or to a plurality of identical products.

Preferably, the quantity of correlated products is indicated in the accompanying document.

The accompanying document can be prepared either by the operator present at the product receiving station or by the supplier of the product(s).

Preferably, said products are placed in respective containers by product type and then said containers are arranged in the transport tray. Alternatively, the containers can be arranged in the transport tray and only subsequently the products are arranged in said containers separating the products by product type. Such operations may be carried out before or after the identification of said products, preferably after the identification of said products.

The products contained in a container placed on a transport tray may be identical to or different from those contained in another container placed in the same transport tray.

Preferably, the accompanying document is placed in the container containing the correlated products. In this way, a visual check or verification of the contents of the containers can be carried out at any time.

Preferably, the transport tray is identified. In this way, the computer system that handles the storage warehouse uniquely associates certain products and quantities of these products with a specific transport tray.

Preferably, identification of the transport tray is carried out before transferring the transport tray from the product receiving station to the intermediate automatic warehouse.

Preferably, identification of the transport tray is carried out by reading a tray identification code associated with the transport tray.

Preferably, the position of each container with respect to the transport tray is identified.

Preferably, the identification of the position of each container with respect to the transport tray is carried out after arranging said containers in the transport tray.

Preferably, the identification of the position of each container with respect to the transport tray is carried out by reading a container positioning identification code associated with the transport tray near the respective container. In this way, the computer system that handles the storage warehouse uniquely associates each container (and thus the products and the quantities of these products contained in each container) with a specific positioning in the transport tray.

Preferably, a intervention request for requesting said first automatic driven vehicle is sent.

This operation can be carried out before transferring the transport tray from the product receiving station to the intermediate automatic warehouse, before or after arranging said products in the transport tray, preferably after arranging said products in the transport tray.

Preferably, after having placed said products in the transport tray and before transferring the transport tray from the product receiving station to the intermediate automatic warehouse, an optical tray completion code associated with the transport tray is read.

Preferably, the transport tray may comprise a first service optical code identifying the possibility of being emptied by a robotic arm.

Preferably, said first service optical code is read.

Preferably, the reading of the first service optical code can be carried out before identifying or after having identified the transport tray, more preferably after having identified the transport tray, and in any case before transferring the transport tray from the product receiving station to the intermediate automatic warehouse.

Preferably, said first service optical code is also printed on said accompanying document.

Preferably, before placing these products in the transport tray, said first service code is read from the accompanying document.

Preferably, after having read the first service optical code from the transport tray, the transport tray is transferred from the intermediate automatic warehouse to a robotic input station of the storage warehouse. This robotic input station is equipped with at least one robotic arm.

Preferably, the transport tray may also comprise a second service optical code identifying that it can only be emptied by an operator.

In this case, before transferring the transport tray from the product receiving station to the intermediate automatic warehouse, this second service optical code is read.

Preferably, after reading the second service optical code, the transport tray is transferred from the intermediate automatic warehouse to a non-robotic input station of the storage warehouse. This non-robotic input station is attended by an operator, who will remove the products from the transport tray and place them in the collection tray.

Preferably, after having stored at least some of said products in said collection tray, the transport tray is transferred from the storage warehouse to the intermediate automatic warehouse by an automatic driven vehicle which coincides or not with said first automatic driven vehicle.

Preferably, before placing said products in the transport tray, the transport tray is transferred from the intermediate automatic warehouse to the product receiving station.

Preferably, this transfer is carried out by an automatic driven vehicle that coincides or not with the first automatic driven vehicle.

Preferably, the transfer of the transport tray from the intermediate automatic warehouse to the product receiving station is preceded by a call made by an operator by actuating a call button.

### BRIEF DESCRIPTION OF THE DRAWINGS

Further features and advantages of the present invention will become clearer from the following detailed description of a preferred embodiment thereof, made with reference to the appended drawings and provided by way of indicative and non-limiting example, in which:

FIG. 1 shows a simplified and schematic layout of an area of a plant in which a process for the automated handling of products to be stored in a storage warehouse in accordance with the present invention is implemented;

FIG. 2 shows a plan view from above of a transport tray used in the process of the present invention;

FIG. 3 shows a side view of the transport tray of FIG. 2;

FIG. 4 shows a plan view from above of an accompanying document used in the process of the present invention;

FIG. 5 shows a plan view from above of a collection tray used in the process of the present invention;

FIG. 6 shows a side view of the collection tray of FIG. 5;

FIG. 7 shows a frame of the transport tray of FIG. 2 analysed by a process management software of the present invention.

### DETAILED DESCRIPTION

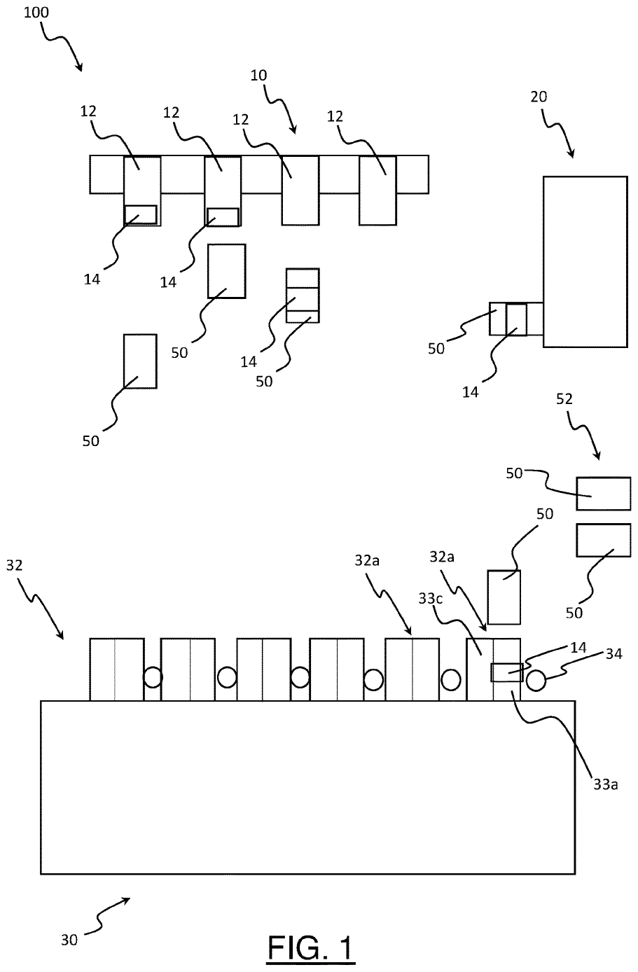

In FIG. 1, numerical reference 100 indicate an area of a plant in which a process for the automated handling of products to be stored in a storage warehouse in accordance with the present invention is implemented.

The products to be stored may come from external suppliers or from other areas of the same plant or from other plants of the same company or corporate group. In a non-limiting example, the products are components or parts of packaging machines, e.g. cigarette packaging machines.

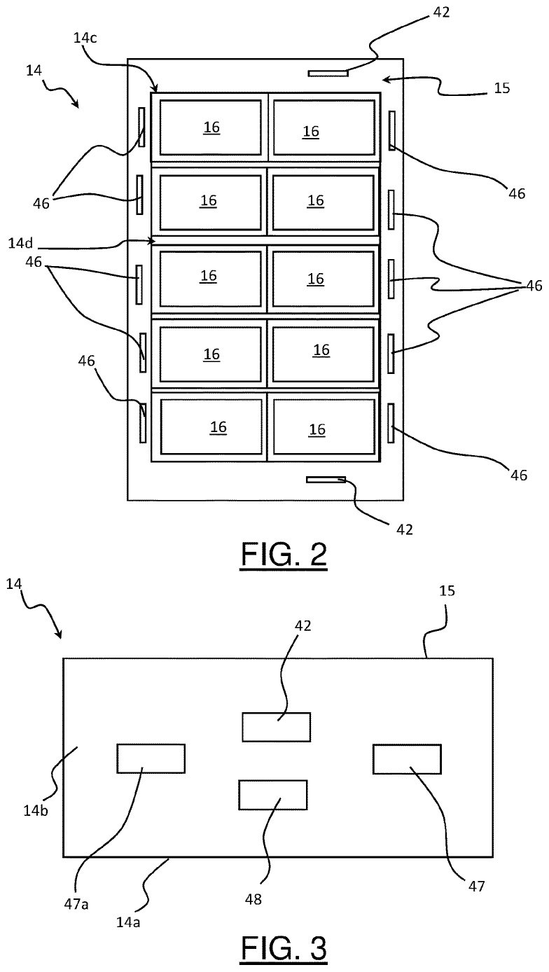

The aforementioned products are initially processed in a product receiving station 10. In this station, the products are placed in containers 16 (FIG. 2), which in turn are arranged in transport trays 14 in order to be temporary stored in an intermediate automatic warehouse 20.

In the area 100 of the plant, in addition to the product receiving station 10 and the automatic intermediate warehouse 20, a storage warehouse 30 is provided, in which the aforementioned products will be stored definitively in order to be picked up as needed.

Preferably the storage warehouse 30 is an automatic warehouse.

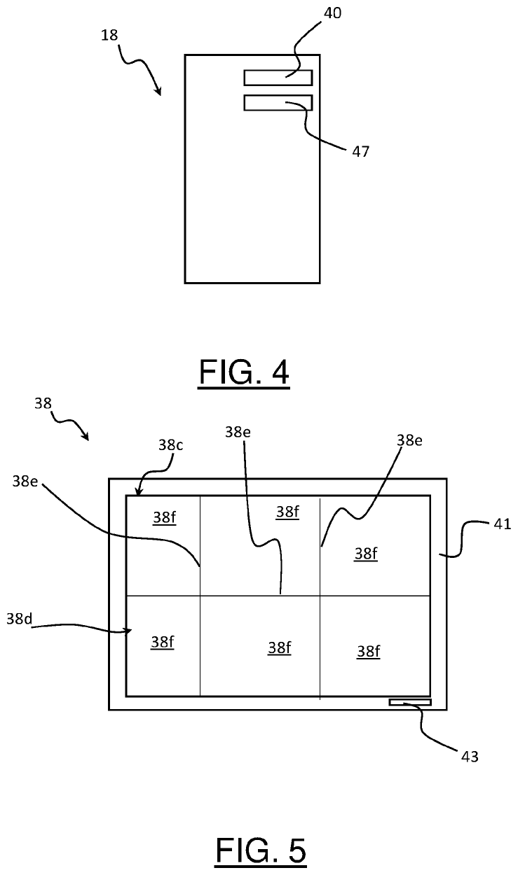

Each product, or each plurality of identical products, present in the product receiving station 10 is accompanied by an accompanying document 18, shown in FIG. 4. This document 18 shows the number and type of products that are correlated thereto. This information is also contained in a product identification code 40 printed on document 18 itself. Preferably, this product identification code 40 is an optical code which can be read by an optical reader, more preferably a bar code.

The accompanying document 18 may be prepared by the operator attending the product receiving station 10 or directly by the supplier of the products and be delivered to the product receiving station 10 together with the products themselves.

In some embodiments, such as the one illustrated herein, a first service optical code 47 is also printed on the accompanying document 18, which identifies the possibility of handling the respective products by a robotic arm 34 provided in a robot input station 32a of the storage warehouse 30 (FIG. 1). However, embodiments are foreseen in which the accompanying document 18 does not have the aforementioned first service optical code 47.

The product receiving station 10 comprises a plurality of product loading stations 12, where various operators place the products to be stored in their respective containers 16 and place the latter in the transport trays 14.

Transport trays 14 without containers 16 are temporarily stored in the intermediate automatic warehouse 20, from which they are taken to be sent to the product loading stations 12. Once loaded with containers 16 at least partially filled with products, the transport trays 14 are returned to the intermediate automatic warehouse 20.

The transfer of each transport tray 14 from the intermediate automatic warehouse 20 to a product loading station 12 takes place after the operator has called an automatic driven vehicle 50 which, starting from a parking area 52 in which a plurality of automatic driven vehicles 50 are present, at first reaches the intermediate automatic warehouse 20 to take a transport tray 14 from the latter and then reaches the product loading station 12. This call is made by the operator e.g. by actuating a call button (not shown) specifically provided at the product loading station 12.

With reference to FIGS. 2 and 3, each transport tray 14 has a substantially parallelepiped shape and comprises a bottom wall 14a, four side walls 14b and, on a side opposite to the bottom wall 14a, an upper perimeter edge 15 delimiting a top opening 14c. The top opening 14c allows access to an essentially parallelepiped-shaped compartment 14d.

In the context of this description and the accompanying claims, spatial references such as “upper”, “top”, “above” or the like, and “bottom”, “below” or the like, are to be understood as referring to the operating position of the transport tray 14 when it rests by its bottom wall 14a.

The compartment 14d accommodates the containers 16, which are ten in the non-limiting example of FIG. 2.

The containers 16 have a substantially parallelepiped shape.

The containers 16 are arranged in the transport tray 14 side by side. In the non-limiting example of FIG. 2, the containers 16 are arranged in two rows of five containers 16 side by side along the respective long sides and along the long sides of the transport tray 14.

Preferably, the containers 16 are storage boxes with open front.

The operator places the products in the transport tray 14, separating them according to product type. Each container 16 therefore contains products of the same type. The containers 16 of the same transport tray 14 may contain identical or even different products. Some containers 16 can contain a single product, if it is large.

The products can be placed in their respective containers 16 before placing the containers 16 in the transport tray 14 or after placing the containers 16 in the transport tray 14.

The products are identified at the product receiving station 10 by reading the product identification code 40 printed on the accompanying document 18.

After loading the products into the container 16, the accompanying document 18 is also placed in the container 16 together with the products that are correlated thereto.

The product identification code 40 can be read before placing or after having placed the products in the containers 16 and before placing or after having placed the containers 16 in the transport tray 14.

Each transport tray 14 has a respective tray identification code 42.

The tray identification code 42 is preferably arranged either on the upper perimeter edge 15 of the transport tray 14, so as to be visible when viewing the transport tray 14 from above, or on a side wall 14b of the transport tray 14.

Preferably, the tray identification code 42 is an optical code, more preferably a bar code, which can be read by an optical reader.

An alphanumeric code that allows a visual identification of the transport tray 14 by operators is associated next to the tray identification code 42.

In the embodiment shown in FIG. 2, two tray identification codes 42 are provided on the upper perimeter edge 15 of the transport tray 14. They are arranged opposite the top opening 14c in a position adjacent to one of the long sides of the transport tray 14. This positioning identifies the row in which the first five containers 16 are to be placed, starting from the left (or from the bottom with reference to the position of the transport tray 14 in FIG. 2) towards the right (or upwards with reference to the position of the transport tray 14 in FIG. 2). The second row of containers 16 is to be positioned adopting a positioning sequence identical to that of the first row of containers 16. For example, with reference to FIG. 7, the ten containers 16 are arranged in succession in the positions numbered I-X, with position I located adjacent to the left-hand tray identification code 42 (or below with reference to the position of the transport tray 14 in FIG. 7), positions II-V arranged side-by-side along the row between the two tray identification codes 42, positions VI-X arranged along a row adjacent to that of positions I-V and close to positions I-V respectively.

Before or after filling the transport tray 14 with containers 16 that are in turn at least partially filled with products, the transport tray 14 is identified by the operator by reading one of the tray identification codes 42.

As shown in FIGS. 2 and 3, the transport tray 14 further comprises, on its upper perimeter edge 15, a plurality of container positioning identification codes 46. Each of these codes 46 is arranged adjacent to a respective zone of the compartment 14d configured to receive a respective container 16.

Preferably, the container positioning identification codes 46 are optical codes, more preferably bar codes, which can be read by an optical reader.

After each container 16 has been placed in transport tray 14, the position of that container 16 (and thus of the products and quantities of products contained therein) with respect to the transport tray 14 is identified by reading the container positioning identification code 46 adjacent to that container 16.

Again with reference to FIG. 3, the transport tray 14 further comprises a first service optical code 47 which identifies the possibility of being emptied by the robotic arm 34 provided in a robotic input station 32a of the storage warehouse 30 (FIG. 1). This code 47 is identical to the first service optical code 47 that may be printed on the accompanying document 18.

In the embodiment illustrated here, the transport tray 14 also comprises a second service optical code 47a, which identifies that it can also be emptied manually by an operator.

The first service optical code 47 and the second service optical code 47a are arranged on the side wall 14b of the transport tray 14 where the tray identification code 42 is also arranged.

Thus, the transport tray 14 shown in the appended figures is suitable for being emptied either by the robotic arm 34 or manually. The operator, by reading either the first service optical code 47 or the second service optical code 47a by an optical reader, determines the type of robotic or manual emptying of the transport tray 14. All the containers 16 contained in a transport tray 14 of which the first service optical code 47 is read will be emptied by a robotic arm, just as all the containers 16 contained in a transport tray 14 of which the second service optical code 47a is read will be emptied manually.

Transport trays 14 containing only the first service optical code 47 can be provided. These trays 14 should only be filled with products accompanied by an accompanying document 18 which also bears the first service optical code 47.

Additional transport trays 14 containing only the second service optical code 47a may also be provided. These trays 14 should only be filled with products accompanied by an accompanying document 18 that does not have the first service optical code 47.

Any reading inconsistencies such as, for example, the reading of a first service optical code 47 on an accompanying document 18 placed in a container 16 and not also on the transport tray 14 in which the container 16 containing that accompanying document 18 and the corresponding products are placed, or vice versa, or the reading of a first service optical code 47 on an accompanying document 18 placed in a container 16 and a second service optical code 47a on the transport tray 14 in which the container 16 containing that accompanying document 18 and the relevant products are placed, generates an alarm signal alerting the operator to make the appropriate checks.

Again with reference to FIG. 3, the transport tray 14 also comprises, on the same side wall 14b where the tray identification code 42 is also arranged, an optical tray completion code 48. The operator reads this optical code 48 to signal to the computer system that handles the storage warehouse 30 that the loading operations of the products into their respective containers 16 and of the latter into the transport tray 14 are complete and therefore that the transport tray 14 can be transferred to the intermediate automatic warehouse 20.

This transfer is carried out by the same automatic driven vehicle 50 that has transferred the transport tray 14 from the intermediate automatic warehouse 20 to the product loading station 12 or by a different automatic driven vehicle 50 specifically called by the operator, e.g. by actuating the aforementioned call button. In this case, the automatic driven vehicle 50 moves from the parking area 52 directly to the product loading station 12 without passing through the intermediate automatic warehouse 20.

The call of the automatic driven vehicle 50 can also be made automatically by reading the optical tray completion code 48.

The transfer of the transport tray 14 from the product receiving station 10 to the automatic driven vehicle 50 and from there to the intermediate automatic warehouse 20 takes place by moving respective conveyors, e.g. roller conveyors.

The intermediate automatic warehouse 20 receives the transport tray 14 from the automatic driven vehicle 50 and stores it inside it at a predefined location until the storage warehouse 30 is ready to receive the products placed in the containers 16 of the transport tray 14.

When the computer system that handles the storage warehouse 30 detects that the storage warehouse 30 is in a condition to receive the products contained in the transport tray 14 which is inside the intermediate automatic warehouse 20, a request to withdraw the transport tray 14is sent to the intermediate automatic warehouse 20.

Following this request, an automatic driven vehicle 50 moves from the parking area 52 to the intermediate automatic warehouse 20 and, after loading the transport tray 14, from the intermediate automatic warehouse 20 to an input area 32 of the storage warehouse 30. The aforementioned other automatic driven vehicle 50 may or may not be the same one that previously brought that same transport tray 14 to the intermediate automatic warehouse 20.

In the input area 32 of the storage warehouse 30, the products placed in the containers 16 contained in the transport tray 14 are transferred to collection trays 38, separated according to their type. The collection trays 38, although not necessarily completely filled, are then placed in a predefined location within the storage warehouse 30.

The input area 32 may comprise a plurality of robotic input stations 32a, as shown in FIG. 1, or both robotic input stations 32a and non-robotic input stations. In the latter case, the automatic driven vehicles 50 transfer the transport trays 14 to the robotic input station 32a or to the non-robotic input station depending on whether the first service optical code 47 or the second service optical code 47a has been read. The input area 32 can also include only non-robotic input stations.

Each robotic input station 32a of the storage warehouse 30 comprises a robotic arm 34 and a feed conveyor 33a. The robotic arm 34 is placed next to the feed conveyor 33a.

The transport tray 14 is transferred from the automatic driven vehicle 50 to the feed conveyor 33a and by the latter to a detection station (not shown) where the transport tray 14 is locked in a fixed position by removable locking elements.

A vision system comprising a camera and a pair of infra-red illuminators is provided in the detection station. The vision system is arranged so that it illuminates the transport tray 14 from above and captures an image of it, such as the one shown in FIG. 7.

This is made in order to detect the tray identification code 42 and to check that the containers 16 and the transport tray 14 are in the correct position.

In the non-limiting example in FIG. 7, the areas which in the image captured by the camera identify the correct positioning of the transport tray 14 (the dashed line defining the dashed rectangle 35d) and the containers 16 (the dashed lines at a short side 35e of each container 16) are indicated by dashed lines. For example, it can be foreseen that in the case of correct positioning the aforementioned dashed lines will be green, while in the case of incorrect positioning the aforementioned dashed lines will turn red. In the latter case, the computer system that handles the storage warehouse 30 warns an operator about the need to manually correct the position of the transport tray 14 and/or the containers 16 until the dashed lines turn green.

The vision system further allows to check the correct spatial orientation of the transport tray 14. This is done by identifying the position of the tray identification codes 42 arranged on the upper perimeter edge 15 of the transport tray 14.

The robotic arm 34 grabs each of the products contained in the containers 16 and releases them into respective collection trays 38.

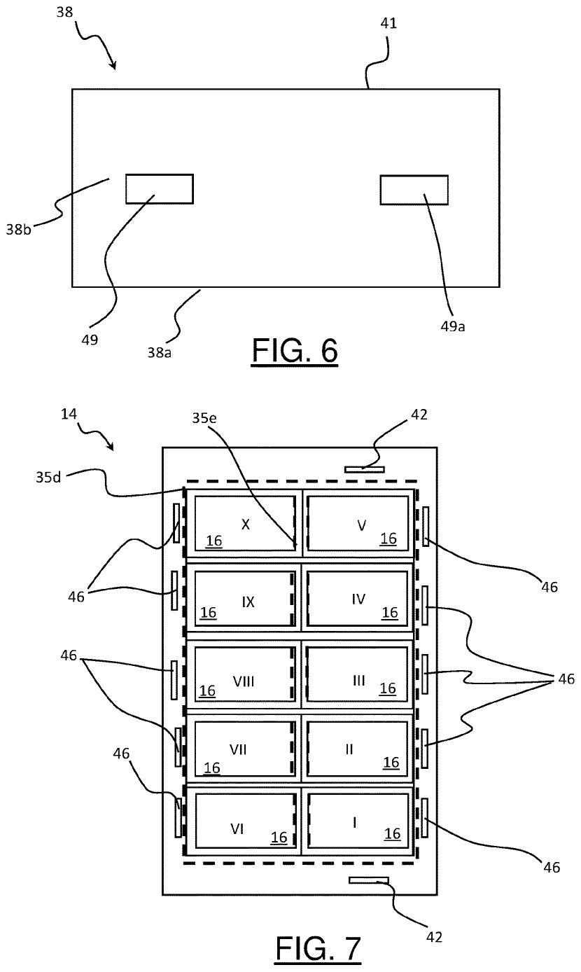

With reference to FIGS. 5 and 6, the collection tray 38 has a substantially parallelepiped shape and comprises a bottom wall 38a, four side walls 38b and, on the side opposite the bottom wall 38a, an upper perimeter edge 41 delimiting a top opening 38c. The top opening 38c allows access to a substantially parallelepiped-shaped compartment 38d. In such a compartment 38d, a plurality of separators 38e, e.g. orthogonal to each other, may be positioned to define a plurality of compartments 38f, e.g. parallelepiped-shaped, which in the non-limiting example of FIG. 5 are six in number.

A tray identification code 43, which is preferably an optical code that can be read by an optical reader, is arranged on the upper perimeter edge 41.

Once all the products taken from a container 16, or from several containers 16 containing identical products, are placed in the collection tray 38, the latter is identified by reading the tray identification code 43.

In addition, the collection tray 38 also comprises a service optical code 49, which identifies that it is suitable for being used in robotic input stations 32a, and an optical tray completion code 49a. The service optical code 49 and the tray completion code 49a are arranged on a side wall 38b of the collection tray 38.

After the robotic arm 34 has placed the products in the collection tray 38, the latter is picked up and placed in the predefined location within the storage warehouse 30.

The transport tray 14 from which the products placed into the collection tray 38 have been taken is transferred from the detection station of the storage warehouse 30 to an unloading conveyor 33c adjacent to the feed conveyor 33a and, by an automatic driven vehicle 50, from the unloading conveyor 33c to the intermediate automatic warehouse 20.

In the non-limiting example of FIG. 1, the feed conveyor 33a and the unloading conveyor 33c are substantially parallel to each other.

Obviously, in order to meet specific and contingent needs, a person skilled in the art will be able to make numerous modifications and changes to the invention described above, all of which being in any case within the scope of protection defined by the following claims.

1. Process A process for the automated handling of products to be stored in a storage warehouse, comprising:
placing said products in a transport tray provided at a product receiving station, separating said products from each other according to product type;
after having placed said products in the transport tray, transferring the transport tray from said product receiving station to an intermediate automatic warehouse by a first automatic driven vehicle;
storing the transport tray in a predefined location within the intermediate automatic warehouse;
when the storage warehouse is ready to receive the products stored in said transport tray, sending to the intermediate automatic warehouse a request to withdraw the transport tray and, following sending the request to withdraw:
transferring the transport tray from the intermediate automatic warehouse to the storage warehouse by an automatic driven vehicle which coincides or not with the first automatic driven vehicle;
picking up said products from the transport tray and putting them in a collection tray provided at the storage warehouse;
storing the collection tray in a predefined location within the storage warehouse.

2. The process according to claim 1, comprising, before placing or after having placed said products in the transport tray, identifying said products in the product receiving station by reading a product identification code correlated to each of said products or to a plurality of identical products.

3. The process according to claim 2, wherein said product identification code is printed on an accompanying document correlated to each of said products or to a plurality of identical products.

4. The process according to claim 2, wherein placing said products in a transport tray comprises:
placing said products in respective containers separating the products according to the product type;
placing said containers in the transport tray.

5. The process according to claim 4, wherein said product identification code is printed on an accompanying document correlated to each of said products or to a plurality of identical products, the process further comprising placing said accompanying document in the container containing the products correlated thereto.

6. The process according to claim 1, comprising, prior to transferring the transport tray from the product receiving station to the intermediate automatic warehouse, identifying the transport tray by reading a tray identification code associated with the transport tray.

7. The process according to claim 6, wherein placing said products in a transport tray comprises:
placing said products in respective containers, separating the products according to the product type;
placing said containers in the transport tray;
the process further comprising, after having placed said containers in the transport tray, identifying a position of each container with respect to the transport tray by reading a container positioning identification code associated with the transport tray near the respective container

8. The process according to claim 1, comprising, before placing or after having placed said products in the transport tray and before transferring the transport tray from the product receiving station to the intermediate automatic warehouse, sending an intervention request for requesting said first automatic driven vehicle.

9. The process according to claim 1, comprising, after having placed said products in the transport tray and before transferring the transport tray from the product receiving station to the intermediate automatic warehouse, reading an optical tray completion code associated with the transport tray

10. The process according to claim 1, wherein the transport tray comprises a first service optical code identifying the a possibility of being emptied by a robotic arm and wherein the process comprises, before identifying or after having identified the transport tray and before transferring the transport tray from the product receiving station to the intermediate automatic warehouse, reading said first service optical code.

11. The process according to claim 10, wherein a product identification code is printed on an accompanying document correlated to each of said products or to a plurality of identical products, the process further comprising placing said accompanying document in a container containing the products correlated thereto, wherein said first service optical code is also printed on said accompanying document and wherein the process comprises, before placing said products in the transport tray, reading said service first code from said accompanying document.

12. The process according to claim 10, wherein, after having read the first service optical code from the transport tray, the transport tray is transferred from the intermediate automatic warehouse to a robotic input station of the storage warehouse.

13. The process according to claim 1, further comprising, after having stored at least some of said products in said collection tray, transferring the transport tray from the storage warehouse to the intermediate automatic warehouse by an automatic driven vehicle which coincides or not with said first automatic driven vehicle.

14. The process according to claim 1, comprising, before placing said products in the transport tray, transferring the transport tray from the intermediate automatic warehouse to the product receiving station by an automatic driven vehicle which coincides or not with said first automatic driven vehicle.

15. The process according to claim 14, wherein transferring the transport tray from the intermediate automatic warehouse to the product receiving station is preceded by a call made by an operator by actuating a call button.
